(19) United States
(12) Patent Application Publication
(10) Pub. No.: US 2011/0098100 A1
(43) Pub. Date: Apr. 28, 2011

(54) SLOT MACHINE WITH MECHANICAL REELS AND VIDEO DISPLAY

(75) Inventors: Yanis Tsombanidis, Las Vegas, NV (US); Scott Monroe Stewart, Las Vegas, NV (US)

(73) Assignee: ARISTOCRAT TECHNOLOGIES AUSTRALIA PTY LIMITED, North Ryde (AU)

(21) Appl. No.: 12/909,468

(22) Filed: Oct. 21, 2010

Related U.S. Application Data
(60) Provisional application No. 61/254,116, filed on Oct. 22, 2009.

(51) Int. Cl. A63F 13/00

(52) U.S. Cl. 463/20

(57) ABSTRACT

A gaming system is disclosed. The gaming system has a mechanical reel and an electronic display.

### CROSS REFERENCE TO RELATED APPLICATIONS

The present application relates to and claims the benefit of priority from U.S. Provisional Patent Application No. 61/254,116, filed on Oct. 22, 2009, which is herein incorporated by reference in its entirety.

### FIELD

The present invention generally relates to a slot machine with mechanical reels, or simulated mechanical reels, and a video display.

### BACKGROUND

Slot machines having either mechanical reels or a video display simulating mechanical reels are known.

While such gaming systems provide players with enjoyment, a need exists for alternative gaming systems in order to maintain or increase player enjoyment.

### SUMMARY

According to a first aspect of the invention there is provided a gaming system comprising:
a mechanical reel;
   an electronic display, the reel and display being constantly independently viewable; and
   a game controller operatively coupled to the reel and the electronic display and configured to cause a visual event comprised of a reel portion and an electronic display portion which interact with one another.

In an embodiment, a person playing on the gaming system is given the impression that the reel portion or the electronic display portion causes the other.

According to a second aspect of the invention there is provided a gaming system comprising:
a mechanical reel;
   an electronic display; and
   a game controller operatively coupled to both the reel and the electronic display and configured to cause a visual event comprised of a reel portion and an electronic display portion such that a person playing on the gaming system is given the impression that the electronic display portion or the reel portion cause the other.

In an embodiment, the visual event occurs during a game playable on the gaming system.

In an embodiment, the electronic display portion comprises an animation and the reel portion is the reel stopping on a certain symbol. The animation may be of the certain symbol moving on the electronic display. The electronic display may be located below the reel. The animation may be of the certain symbol falling. Alternatively, the display may be located above the reel. The animation may be of the certain symbol rising. The animation may be the appearance of the certain symbol on the electronic display.

In an embodiment, the electronic display portion is indicative of a direction the reel spins.

In an embodiment, the reel portion comprises the reel stopping at a certain symbol and the electronic display portion is consistently associated with the reel stopping at the certain symbol.

In an embodiment, the electronic display portion is indicative of the reel being respun.

In an embodiment, the controller causes the electronic display portion to start on or after the reel stops on a generic symbol. The controller may cause the generic symbol to change on or after the start of the electronic display portion. The electronic display portion may be indicative of the change of the generic symbol. The change may be a change in a colour.

In an embodiment, the gaming system comprises another electronic display, the controller being operatively coupled to the other electronic display, and the visual event is further comprised of another electronic display portion on the other electronic display. The controller may cause the electronic display portion, then the reel portion, and then the other electronic display portion on the other electronic display.

In an embodiment, the gaming system further comprises a display area wherein the reel and electronic display(s) form an array over the display area. The array may be horizontal. Alternatively, the array may be vertical.

In an embodiment, the reel is adjacent to the electronic display(s).

In an embodiment, the reel and display are constantly independently viewable.

According to a third aspect of the invention there is provided a game controller configured to be operatively coupled to a reel and an electronic display and configured to cause a visual event comprised of a reel portion and an electronic display portion which interact with one another.

According to a fourth aspect of the invention there is provided a game controller configured to be operatively coupled to both a reel and an electronic display and cause a visual event comprised of a reel portion and an electronic display portion such that a person playing on the gaming system is given the impression that the electronic display portion or the reel portion cause the other.

According to a fifth aspect of the invention there is provided a gaming system comprising:
a mechanical reel simulated on an electronic display;
   a moving image presentation area on the, or another, electronic display, the simulated mechanical reel and moving image presentation area being constantly independently viewable; and
   a controller operatively coupled to the display(s) and configured to cause a visual event comprised of a reel portion and presentation area portion which interact with one another.

According to a sixth aspect of the invention there is provided a gaming system comprising:
a mechanical reel simulated on an electronic display;
a moving image presentation area on the, or another, electronic display; and
a controller operatively coupled to the display(s) and configured to cause a visual event comprised of a reel portion and a presentation area portion such that a person playing on the gaming system is given the impression that one of the reel portion and the presentation portion caused the other.

According to a seventh aspect of the invention there is provided a method comprising causing on a gaming system a visual event comprised of a reel portion and an electronic display portion which interact with one another.

According to an eighth aspect of the invention there is provided a method comprising causing on a gaming system a visual event comprised of a reel portion and an electronic display portion such that a person is given the impression that the electronic display portion or the reel portion cause the other.

According to a ninth aspect of the invention there is provided a computer program comprising instructions for controlling a computer to implement a method disclosed herein. The computer program may be in the form of software.

According to an tenth aspect of the invention there is provided a computer readable medium providing a computer program in accordance with the ninth aspect of the invention. The computer readable medium may be tangible.

### BRIEF DESCRIPTION OF DRAWINGS

Certain exemplary embodiments of the invention will now be described with reference to the accompanying drawings in which:

FIG. 1 is a block diagram of the core components of an embodiment of a gaming system;

FIG. 2 is a perspective view of an embodiment of a stand alone gaming machine;

FIG. 3 is a block diagram of the functional components of an embodiment of a gaming machine;

FIG. 4 is a schematic diagram of an embodiment of the functional components of a memory;

FIG. 5 is a schematic diagram of an embodiment of a network gaming system;

FIG. 6 is a further block diagram of an embodiment of a gaming system;

FIGS. 7 and 8 are flow charts of embodiments; and

FIGS. 9 through 12 are various examples of display areas showing various visual events involving mechanical reels together with one or more electronic displays.

Features, further aspects, and advantages of the present invention will become apparent from the following description of embodiments thereof, by way of example only, with reference to the accompanying drawings. Also, various embodiments of the aspects described in the preceding paragraphs will be apparent from the appended claims, the following description and/or the accompanying drawings. It should be understood, however, that the present invention is not limited to the arrangements and instrumentality shown in the attached drawings.

### DETAILED DESCRIPTION

Although the following discloses example methods, systems, articles of manufacture, and apparatus including, among other components, software executed on hardware, it should be noted that such methods and apparatus are merely illustrative and should not be considered as limiting. For example, it is contemplated that any or all of these hardware and software components could be embodied exclusively in hardware, exclusively in software, exclusively in firmware, or in any combination of hardware, software, and/or firmware. Accordingly, while the following describes example methods, systems, articles of manufacture, and apparatus, the examples provided are not the only way to implement such methods, systems, articles of manufacture, and apparatus.

When any of the appended apparatus claims are read to cover a purely software and/or firmware implementation, in at least one embodiment, at least one of the elements is hereby expressly defined to include a tangible medium such as a memory, DVD, CD, etc., storing the software and/or firmware.

Referring to the drawings, there is shown a gaming system having a game controller arranged to implement a game.

The gaming system presents to a player of the game a plurality of reels and an electronic display. In this embodiment the reels are mechanical, however in another embodiment the mechanical reels are simulated on the or another electronic display. In this embodiment, the electronic display is of a type suitable for the display of animations. During the game, a visual event is caused which involves one or more of the reels and also the electronic display. The portion of the visual event that involves the reels constitutes a reel portion, and the portion of the event that involves the electronic display constitutes an electronic display portion. The reel portion and the electronic display portion interact, and may in some embodiments even give the player the impression that the reel portion causes the electronic display portion or vice versa.

The gaming system can take a number of different forms. In a first form, a stand alone gaming machine is provided wherein all or most components to implement the game are present in a player operable gaming machine.

In a second form, a distributed architecture is provided wherein some of the components to implement the game are present in a player operable gaming machine and some of the components to implement the game are located remotely relative to the gaming machine. For example, a “thick client” architecture may be used wherein part of the game is executed on a player operable gaming machine and part of the game is executed remotely, such as by a gaming server; or a “thin client” architecture may be used wherein most of the game is executed remotely such as by a gaming server and a player operable gaming machine is used only to display audible and/or visible gaming information to the player and receive gaming inputs from the player.

However, it will be understood that other arrangements are envisaged. For example, an architecture may be provided wherein a gaming machine is networked to a gaming server and the respective functions of the gaming machine and the gaming server are selectively modifiable. For example, the gaming system may operate in stand alone gaming machine mode, “thick client” mode or “thin client” mode depending on the game being played, operating conditions, and so on. Other variations will be apparent to persons skilled in the art.

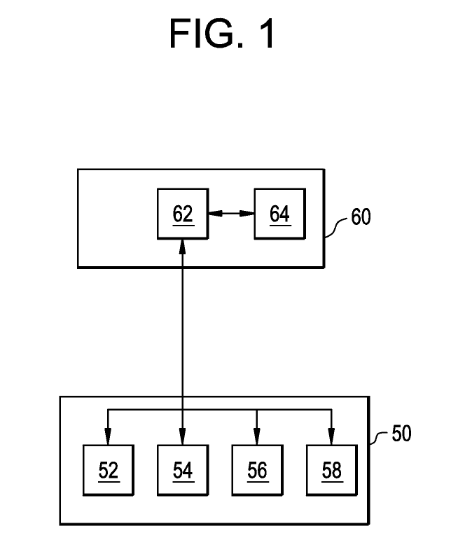

Irrespective of the form, the gaming system has several core components. At the broadest level, the core components are a player interface 50 and a game controller 60 as illustrated in FIG. 1. The player interface is arranged to enable manual interaction between a player and the gaming system and for this purpose includes the input/output components for the player to enter instructions to play the game and observe the game outcomes.

The game controller 60 is operatively coupled to the reels and the electronic display(s) which are collectively indicated by numeral 54 in FIG. 1. The controller 60 causes the visual event on the reels and electronic display(s) 54.

Components of the player interface may vary from embodiment to embodiment but will typically include a credit mechanism 52 to enable a player to input credits and receive payouts, one or more displays such as the reel and an electronic (or video) display 54, a game play mechanism 56 including one or more input devices that enable a player to input game play instructions (e.g. to place a wager), and one or more speakers 58.

The game controller 60 is in data communication with the player interface and typically includes a processor 62 that processes the game play instructions in accordance with game play rules and outputs game play outcomes to the displays. Typically, the game play rules are stored as program code in a memory 64 but can also be hardwired. Herein the term “processor” is used to refer generically to any device that can process game play instructions in accordance with game play rules and may include: a microprocessor, microcontroller, programmable logic device or other computational device, a general purpose computer (e.g. a PC) or a server.

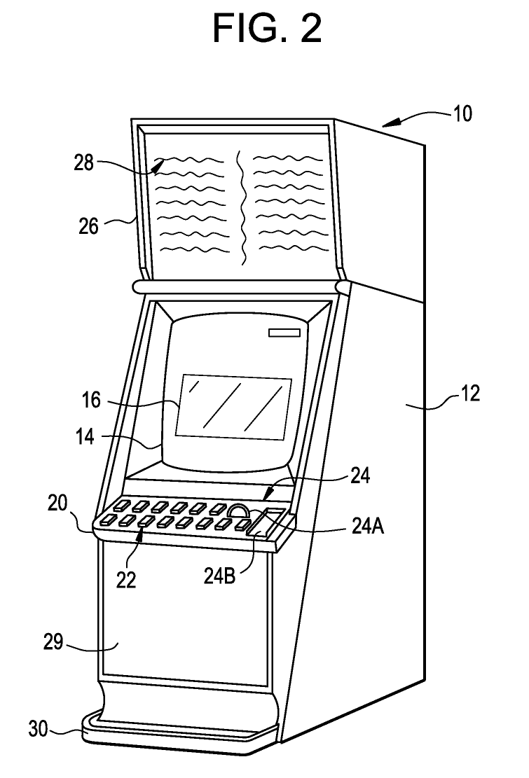

A gaming system in the form of a stand alone gaming machine 10 is illustrated in FIG. 2. The gaming machine 10 includes a console 12 having a display 14 on which are displayed representations of a game that can be played by a player.

In some embodiments, the plurality of mechanical reels such as 15 are grouped in a block of reels. The electronic display and block of reels are presented on a display area. The reels may be located above, below or to one side of the electronic display. In another embodiment, there are two electronic displays which may each respectively sit above and below (or alternatively either side of) the plurality of reels. In these embodiments, the block of reels and the electronic displays form an array. The array may, for example, be either vertically or horizontally orientated, or may even have some other orientation. Typically, the array components are adjacent but may in some embodiments be spaced apart. In an embodiment, the block of reels and electronic display(s) may have an arbitrary spatial relationship.

A mid-trim 20 of the gaming machine 10 houses a bank of buttons 22 for enabling a player to interact with the gaming machine, in particular during game play. The mid-trim 20 also houses a credit input mechanism 24 which in this example includes a coin input chute 24A and a bill collector 24B. Other credit input mechanisms may also be employed, for example, a card reader for reading a smart card, debit card or credit card. Other gaming machines may configure for ticket in such that they have a ticket reader for reading tickets having a value and crediting the player based on the face value of the ticket. A player marketing module (not shown) having a reading device may also be provided for the purpose of reading a player tracking device, for example as part of a loyalty program. The player tracking device may be in the form of a card, flash drive or any other portable storage medium capable of being read by the reading device. In some embodiments, the player marketing module may provide an additional credit mechanism, either by transferring credits to the gaming machine from credits stored on the player tracking device or by transferring credits from a player account in data communication with the player marketing module.

A top box 26 may carry artwork 28, including for example pay tables and details of bonus awards and other information or images relating to the game. Further artwork and/or information may be provided on a front panel 29 of the console 12. A coin tray 30 is mounted beneath the front panel 29 for dispensing cash payouts from the gaming machine 10.

The display 14 shown in FIG. 2 is in the form of a video display unit, particularly a cathode ray tube screen device. Alternatively, the display 14 may be a liquid crystal display, plasma screen, any other suitable video display unit, or the visible portion of an electromechanical device. The top box 26 may also include a display, for example a video display unit, which may be of the same type as the display 14, or of a different type.

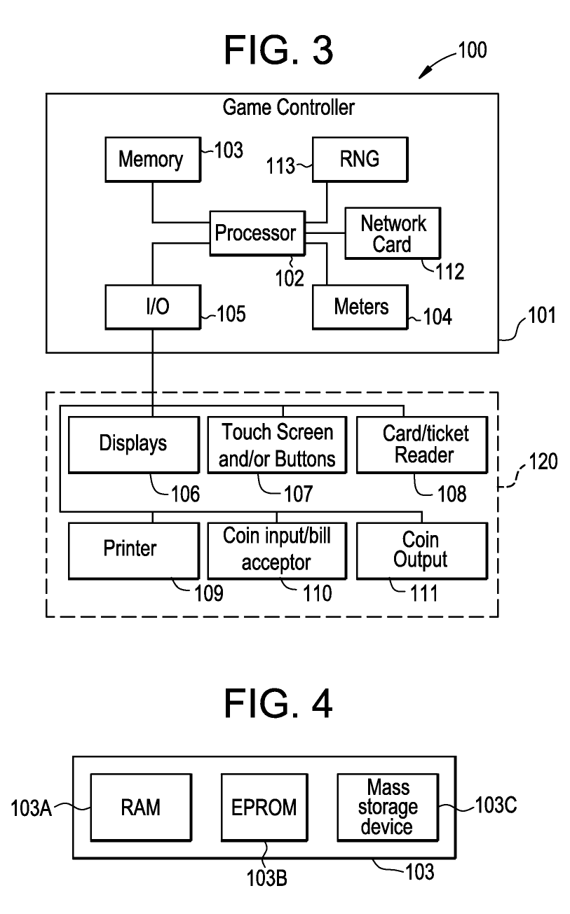

FIG. 3 shows a block diagram of operative components of a typical gaming machine which may be the same as or different to the gaming machine of FIG. 2.

The gaming machine 100 includes a game controller 101 having a processor 102 mounted on a circuit board. Instructions and data to control operation of the processor 102 are stored in a memory 103, which is in data communication with the processor 102. Typically, the gaming machine 100 will include both volatile and non-volatile memory and more than one of each type of memory, with such memories being collectively represented by the memory 103.

The gaming machine has hardware meters 104 for purposes including ensuring regulatory compliance and monitoring player credit, an input/output (I/O) interface 105 for communicating with peripheral devices of the gaming machine 100. The input/output interface 105 and/or the peripheral devices may be intelligent devices with their own memory for storing associated instructions and data for use with the input/output interface or the peripheral devices. A random number generator module 113 generates random numbers for use by the processor 102. Persons skilled in the art will appreciate that the reference to random numbers includes pseudo-random numbers.

In the example shown in FIG. 3, a player interface 120 includes peripheral devices that communicate with the game controller 101 including one or more displays such as electronic display(s) and reels 106, a touch screen and/or buttons 107 (which provide a game play mechanism), a card and/or ticket reader 108, a printer 109, a bill acceptor and/or coin input mechanism 110 and a coin output mechanism 111. Additional hardware may be included as part of the gaming machine 100, or hardware may be omitted based on the specific implementation. For example, while buttons or touch screens are typically used in gaming machines to allow a player to place a wager and initiate a play of a game any input device that enables the player to input game play instructions may be used. For example, in some gaming machines a mechanical handle is used to initiate a play of the game.

In addition, the gaming machine 100 may include a communications interface, for example a network card 112. The network card may, for example, send status information, accounting information or other information to a bonus controller, central controller, server or database and receive data or commands from the bonus controller, central controller, server or database. In embodiments employing a player marketing module, communications over a network may be via player marketing module—i.e. the player marketing module may be in data communication with one or more of the above devices and communicate with it on behalf of the gaming machine.

FIG. 4 shows a block diagram of the main components of an exemplary memory 103. The memory 103 includes RAM 103A, EPROM 103B and a mass storage device 103C. The RAM 103A typically temporarily holds program files for execution by the processor 102 and related data. The EPROM 103B may be a boot ROM device and/or may contain some system or game related code. The mass storage device 103C is typically used to store game programs, the integrity of which may be verified and/or authenticated by the processor 102 using protected code from the EPROM 103B or elsewhere.

It is also possible for the operative components of the gaming machine 100 to be distributed, for example input/output devices 106,107,108,109,110,111 to be provided remotely from the game controller 101.

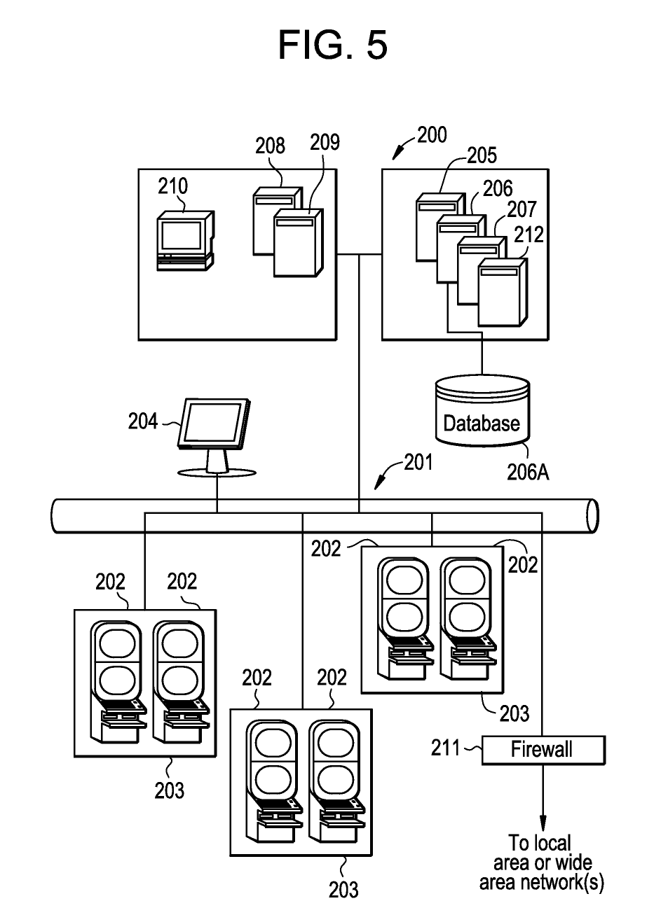

FIG. 5 shows a gaming system 200 in accordance with an alternative embodiment. The gaming system 200 includes a network 201, which for example may be an Ethernet network. Gaming machines 202, shown arranged in three banks 203 of two gaming machines 202 in FIG. 5, are connected to the network 201. The gaming machines 202 provide a player operable interface and may be the same as the gaming machines 10,100 shown in FIGS. 2 and 3, or may have simplified functionality depending on the rules, guidelines, preferences, and/or requirements for implementing game play. While banks 203 of two gaming machines are illustrated in FIG. 5, banks of one, three or more gaming machines are also envisaged.

One or more displays 204 may also be connected to the network 201. For example, the displays 204 may be associated with one or more banks 203 of gaming machines. The displays 204 may be used to display representations associated with game play on the gaming machines 202, and/or used to display other representations, for example promotional or informational material.

In a thick client embodiment, game server 205 implements part of the game played by a player using a gaming machine 202 and the gaming machine 202 implements part of the game. With this embodiment, as both the game server and the gaming device implement part of the game, they collectively provide a game controller. A database management server 206 may manage storage of game programs and associated data for downloading or access by the gaming devices 202 in a database 206A. Typically, if the gaming system enables players to participate in a Jackpot game, a Jackpot server 207 will be provided to perform accounting functions for the Jackpot game. A loyalty program server 212 may also be provided.

In a thin client embodiment, game server 205 implements most or all of the game played by a player using a gaming machine 202 and the gaming machine 202 essentially provides only the player interface. With this embodiment, the game server 205 provides the game controller. The gaming machine will receive player instructions, pass these to the game server which will process them and return game play outcomes to the gaming machine for display. In a thin client embodiment, the gaming machines could be computer terminals, e.g. PCs running software that provides a player interface operable using standard computer input and output components. Other client/server configurations are possible, and further details of a client/server architecture can be found in WO 2006/052213 and PCT/SE2006/000559, the disclosures of which are incorporated herein by reference.

Servers are also typically provided to assist in the administration of the gaming network 200, including for example a gaming floor management server 208, and a licensing server 209 to monitor the use of licenses relating to particular games. An administrator terminal 210 is provided to allow an administrator to run the network 201 and the devices connected to the network.

The gaming system 200 may communicate with other gaming systems, other local networks, for example a corporate network, and/or a wide area network such as the Internet, for example through a firewall 211.

Persons skilled in the art will appreciate that in accordance with known techniques, functionality at the server side of the network may be distributed over a plurality of different computers. For example, elements may be run as a single “engine” on one server or a separate server may be provided. For example, the game server 205 could run a random generator engine. Alternatively, a separate random number generator server could be provided. Further, persons skilled in the art will appreciate that a plurality of game servers could be provided to run different games or a single game server may run a plurality of different games based on the terminals.

### Further Detail of Gaming System

The player operates the game play mechanism 56 to specify the win entitlement which will be evaluated for this play of the game and initiates a play of the game. Persons skilled in the art will appreciate that a player's win entitlement will vary from game to game dependent on player selections. In most spinning reel games, it is typical for the player's entitlement to be affected by the amount they wager and selections they make (i.e. the nature of the wager). For example, a player's win entitlement may be based on how many lines they play in each game—e.g. a minimum of one line up to the maximum number of lines allowed by the game (noting that not all permutations of win lines may be available for selection). Such win lines are typically formed by a combination of symbol display positions, one from each reel, the symbol display positions being located relative to one another such that they form a line.

In many games, the player's win entitlement is not strictly limited to the lines they have selected, for example, “scatter” pays are awarded independently of a player's selection of pay lines and are an inherent part of the win entitlement.

Persons skilled in the art, will appreciate that in other embodiments, the player may obtain a win entitlement by selecting a number of reels to play. Such games are marketed under the trade name “Reel Power” by Aristocrat Leisure Industries Pty Ltd. The selection of the reel means that each displayed symbol of the reel can be substituted for a symbol at one or more designated display positions. In other words, all symbols displayed at symbol display positions corresponding to a selected reel can be used to form symbol combinations with symbols displayed at a designated, symbol display positions of the other reels. For example, if there are five reels and three symbol display positions for each reel such that the symbol display positions comprise three rows of five symbol display positions, the symbols displayed in the centre row are used for non-selected reels. As a result, the total number of ways to win is determined by multiplying the number of active display positions of each reels, the active display positions being all display positions of each selected reel and the designated display position of the non-selected reels. As a result for five reels and fifteen display positions there are 243 ways to win.

In other embodiments a player win entitlement may be affected by purchasing access to particular pay tables—e.g. a first bet amount entitles the player to wins including cherries and a second amount entitles them to wins including plums.

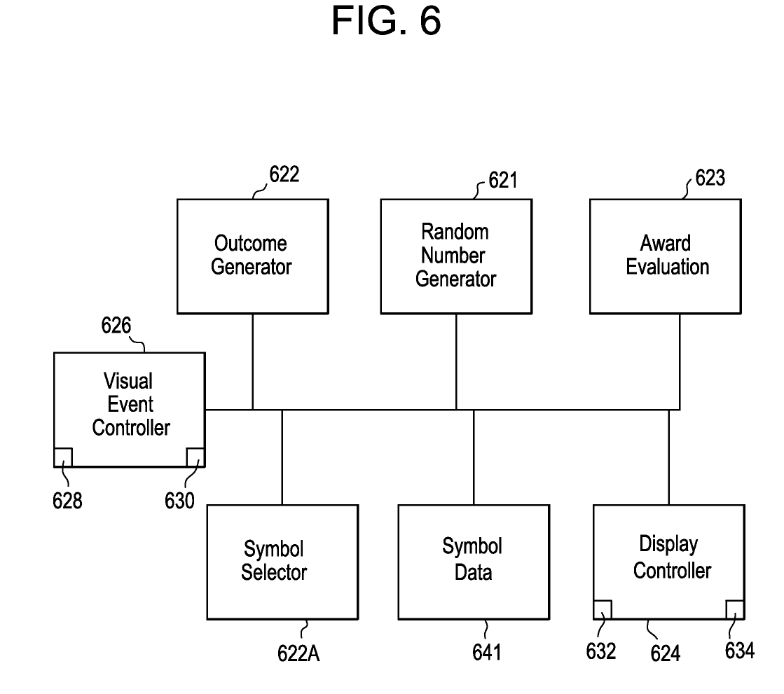

In FIG. 6, the processor 62 of game controller 60 is shown implementing a number of modules based on program code and data stored in memory 64. Persons skilled in the art will appreciate that various of the modules could be implemented in some other way, for example by a dedicated circuit.

These modules include the outcome generator 622 which operates in response to the player's operation of game play mechanism 56 to place a wager and initiate a play of the game and generates a game outcome which will then be evaluated by award evaluator 623. The first part of forming the game outcome is for a symbol selector 622A to select symbols from a set of symbols specified by symbol data 641 using random number generator 621. The selected symbols are advised to the display controller 624 which causes them to be displayed on display 54 at a set of display positions.

One example of selecting symbols is for the symbol selector 622A to select symbols for display from a plurality of symbol sets corresponding to respective ones of a plurality of spinning reels. The symbol sets 641 can specify a sequence of symbols for each reel such that the symbol selector 622A can select all of the symbols by selecting a stopping position in the sequence. In one example, three symbols of each of five reels may be displayed such that symbols are displayed at fifteen display positions on display 54. It is known to use a probability table stored in memory 64 to vary the odds of a particular stop position being selected. Other techniques can be used to control the odds of particular outcomes occurring to thereby control the return to player of the game.

The processor may have a visual event controller 626, for controlling and coordinating a visual event. The visual event controller 626 may have a sub-unit 628 for controlling a reel portion of the visual event (reel portion controller”) and another sub-unit 630 for controlling an electronic display portion of the visual event (“electronic display portion controller”). The event controller communicates with the display controller. The display controller may have a sub-unit (632) for controlling the reels, and another sub-unit (634) for controlling the electronic display.

In some embodiments, an eligibility criteria may be applied, for example that the player has made a certain sized wager, made an ante bet, selected all win lines, played sufficient games, or the player is a member of a loyalty program.

The trigger event may be a symbol combination in the game, occurrence of a specific symbol in the game, purchased, be caused by another connected system, based on turnover etc.

A game round involves at least one of the reels being “spun”—e.g. new symbols of the reels are selected for display at the display positions and the reel is either physically or virtually spun to a stop. Persons skilled in the art will appreciate that there may be more than one game round in a play of a gaming machine such as is the case when a series of free spins is awarded. The outcome of a game round may be no win, a win (for example from a winning combination of symbols), a contribution towards a win accrued over a plurality of game rounds, a trigger condition occurring etc.

### Examples of Visual Events

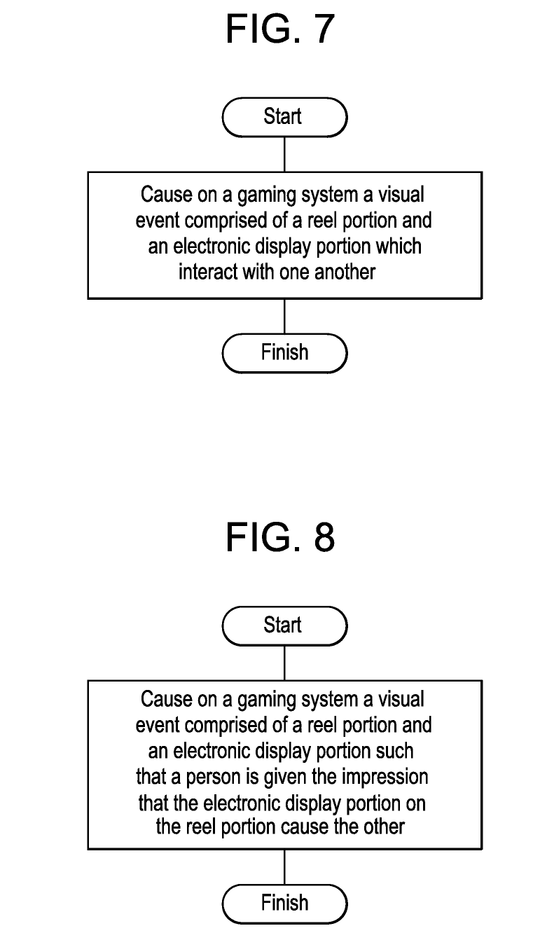

FIGS. 7 and 8 show flow diagrams of embodiments of methods executed by the gaming system. FIGS. 7 and 8 include flow and/or data sequence diagrams representative of machine readable and executable instructions or processes that can be executed to implement the example systems, apparatus, and article of manufacture described herein. The example processes of FIGS. 7 and 8 can be performed using a processor, a controller and/or any other suitable processing device. For example, the example processes of FIGS. 7 and 8 can be implemented in coded instructions stored on a tangible medium such as a flash memory, a read-only memory (ROM) and/or random-access memory (RAM) associated with a processor. Alternatively, some or all of the example processes of FIGS. 7 and 8 can be implemented using any combination(s) of application specific integrated circuit(s) (ASIC(s)), programmable logic device(s) (PLD(s)), field programmable logic device(s) (FPLD(s)), discrete logic, hardware, firmware, etc. Also, some or all of the example processes of FIGS. 7 and 8 can be implemented manually or as any combination(s) of any of the foregoing techniques, for example, any combination of firmware, software, discrete logic and/or hardware. Further, although the example processes of FIGS. 7 and 8 are described with reference to the flow diagrams of FIGS. 7 and 8, other methods of implementing the processes of FIGS. 7 and 8 can be employed. Additionally, any or all of the example processes of FIGS. 7 and 8 can be performed sequentially and/or in parallel by, for example, separate processing threads, processors, devices, discrete logic, circuits, etc.

As shown in the example of FIG. 7, a visual event is caused on a gaming system. The visual event includes a reel portion and an electronic display portion which interact with one another. As shown in the example of FIG. 8, a visual event is caused on a gaming system. The visual event includes a reel portion and an electronic display portion. The reel portion and the electronic display portion are generated in the visual event such that a person is given the impression that one of the electronic display portion or the reel portion causes the other. Some examples of the visual events generated are now discussed.

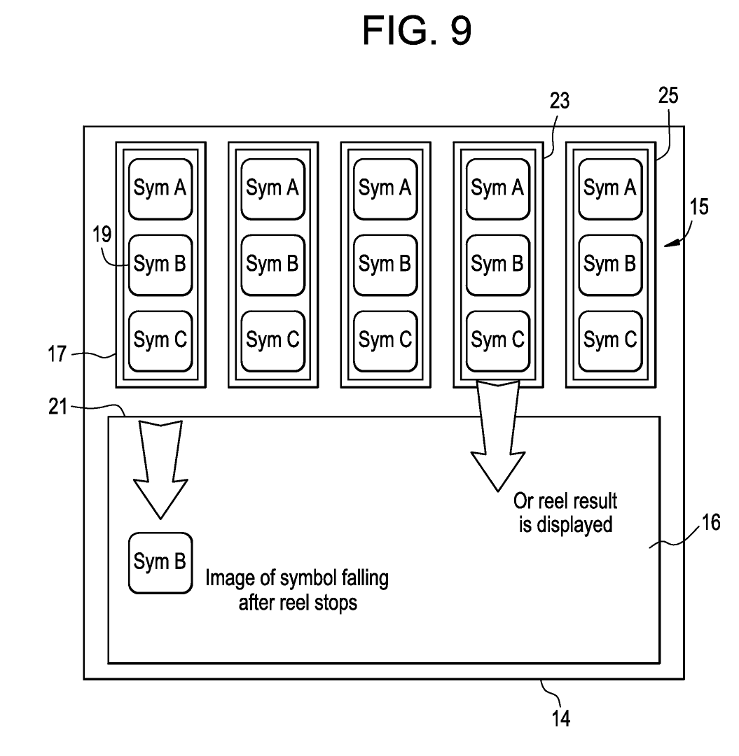

FIG. 9 shows an example display area 14 of a gaming system. The display area comprises a plurality of reels 15 arranged in a block and also an adjacent electronic display 16 located below the reel block. The reels and display are constantly independently viewable such that a player's view of the reels does not interfere with that of the electronic display, and vice versa.

In this example, the reel portion of the visual event comprises the reel 17 spinning and then stopping such that the symbol B 19 is located on a pay line when the reel stops. Of course the symbol could be any suitable symbol. Subsequent to the reel stopping, the controller 60 which caused the reel portion of the visual event, starts the display portion of the visual event. In this embodiment, the display portion includes an animation of the symbol B falling from the top edge 21 of the display to the middle of the display 16 at which point the symbols stops falling. The symbol may stop at some other point, such as along the bottom edge of the electronic display.

In this and other examples, the symbol may not move in a straight line. For example, it may follow a path that comprises one or more of segments and curves. It may take part in a larger animation. It may change its appearance as it moves, or interact with other components of the larger animation.

In another example, in the reel portion of the visual event, the reel 23 stops on symbol B, and the controller then causes symbol B to appear below the reel 23 on the centre line of the electronic display 16. It may for example, suddenly appear, fade in, bounce or otherwise come in from a side of the electronic display, or appear in any number of suitable ways.

Because the symbol B on the other reels such as reel 25 do not fall upon a pay line there is, at least in this example, no subsequent action on the display 16.

It will be appreciated that the relative position of the electronic display 16 and the block of reels 15 could be reversed so that the electronic display is above the block of reels 15. In this case, the reel stopping on a particular symbol may be accompanied or followed by the symbol rising from the bottom edge of the display 16, and the symbol may stop along the mid-line or rise to the very top of the electronic display 16. Generally any “rising” animation may be exhibited.

In other examples, the symbol that appears on the electronic display may not be the same symbol as that is located on a pay line of the respective reel when stopped. Rather, it could be some other symbol. The symbol on the electronic display 16 may be regularly associated with the symbol on the reel, such as 19. For example, a picture of a grinning monarch may appear on the display 16 if the symbol on the reel 19 is a coin. In alternative embodiments, the symbol to appear on the display 16 is determined on some other condition in association with the symbol on the pay line of the reel. For example, a pair of particular symbols should be located on the pay line before the display portion is triggered.

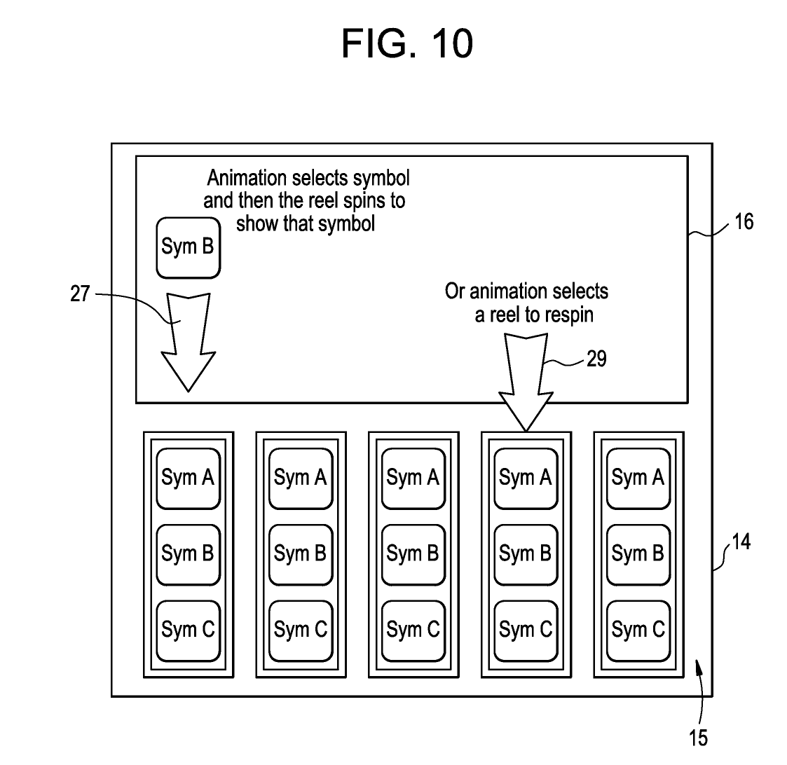

FIG. 10 shows another example of a display area 14 having a block of reels 15 and electronic display 16. In this embodiment, a display portion in the form of an animation may appear on the electronic display which is located above the block of reels 15. The animation would appear to cause the reel to move in an indicated direction, for example as indicated by an arrow such as 27. The reel may appear to be forced to respin and stop to display a specific symbol in concordance with a symbol displayed on the electronic display 16, possibly directly but not necessarily above the respective reel. Alternatively, an animation may appear on the screen 16, such as represented by 29 which would appear to cause the reel indicated by the arrow 29 to respin.

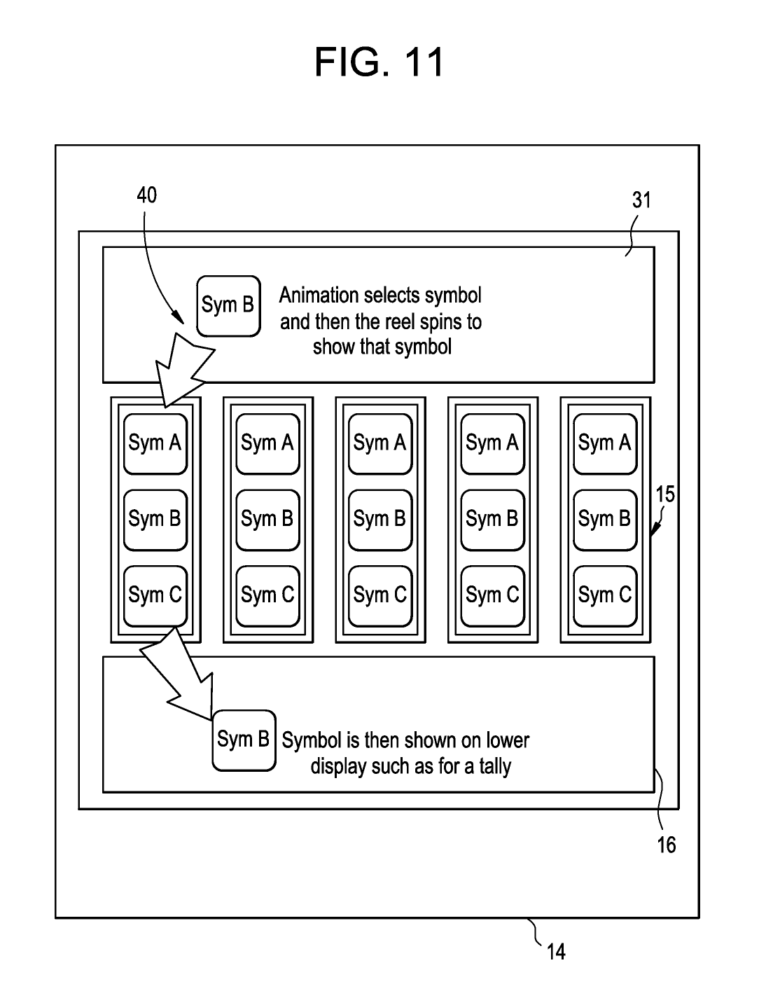

FIG. 11 shows another example of a display area 14. In this example, the block of reels 15 is located between a pair of electronic displays 16 and 31 above and below the reel block 15 respectively. In this example, an animation 40 in the top electronic display 31 indicates that the reel should spin and show a particular symbol. After this first electronic display portion, the reel spins in the indicated direction and stops to display the indicated symbol on a pay line. Once the reel portion has finished, at least in this embodiment, the controller may cause a second electronic display portion of the visual effect which is the symbol on the reel and pay line being shown on the lower electronic display 16. In an embodiment, a tally may be kept on the lower display of the number of symbols of a particular type that have come up, for example. Any suitable interacting event portions between the reels and the electronic displays may be similarly exhibited.

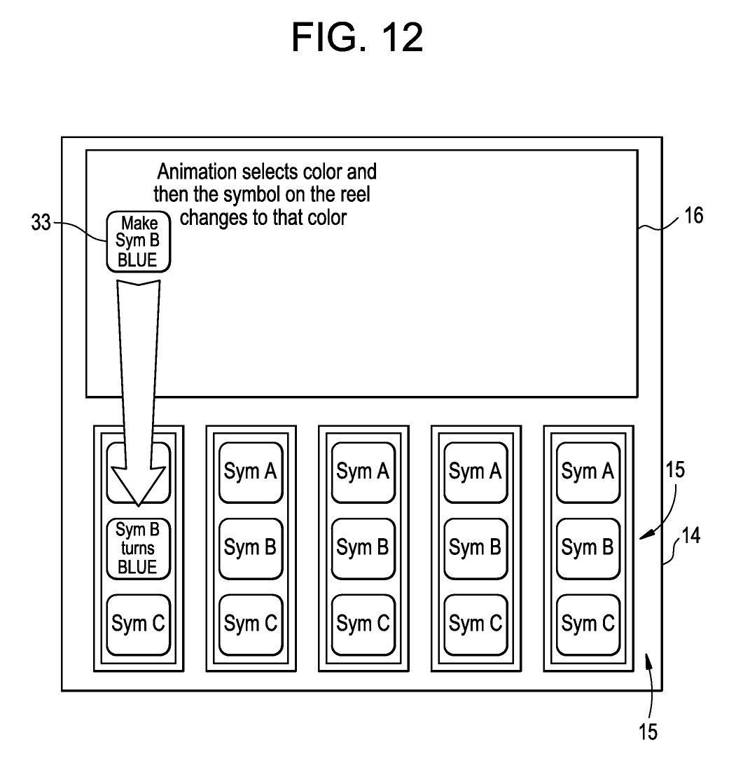

FIG. 12 shows another example of a display area 14 having a block of reels 15 and an electronic display 16. In this example, an animation appears in the electronic display 16 indicated by the numeral 33. The animation may indicate that some modification should occur to the symbol displayed on the central pay line when the reel stops, for example. In one example, the animation indicates that the symbol the reel has stopped at should change colours, from white to blue for example. Alternatively, the animation may indicate that the symbol the reel stopped at should change to another type of symbol. The final state of the symbol after the visual event is then used in determining if a win or some other condition has been met. For example, a different coloured symbol may indicate a different amount payout.

Further aspects of the method will be apparent from the above description of the gaming system. Persons skilled in the art will also appreciate that the method could be embodied in program code. The program code could be supplied in a number of ways, for example on a computer readable storage medium, such as a disc or a memory (for example, that could replace part of memory 103) or as a data signal (for example, by transmitting it from a server).

It will be understood to persons skilled in the art of the invention that many modifications may be made without departing from the spirit and scope of the invention, in particular it will be apparent that certain features of embodiments of the invention can be employed to form further embodiments.

It is to be understood that, if any prior art is referred to herein, such reference does not constitute an admission that the prior art forms a part of the common general knowledge in the art in any country.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive. Several embodiments are described above with reference to the drawings. These drawings illustrate certain details of specific embodiments that implement the systems and methods and programs of the present invention. However, describing the invention with drawings should not be construed as imposing on the invention any limitations associated with features shown in the drawings. It will be understood that the invention disclosed and defined in this specification extends to all alternative combinations of two or more of the individual features mentioned or evident from the text or drawings. All of these different combinations constitute various alternative aspects of the invention.

The present invention contemplates methods, systems and program products on any electronic device and/or machine-readable media suitable for accomplishing its operations. Certain embodiments of the present invention may be implemented using an existing computer processor and/or by a special purpose computer processor incorporated for this or another purpose or by a hardwired system, for example.

Embodiments within the scope of the present invention include program products comprising machine-readable media for carrying or having machine-executable instructions or data structures stored thereon. Such machine-readable media can be any available media that can be accessed by a general purpose or special purpose computer or other machine with a processor. By way of example, such machine-readable media may comprise RAM, ROM, PROM, EPROM, EEPROM, Flash, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such a connection is properly termed a machine-readable medium. Combinations of the above are also included within the scope of machine-readable media. Machine-executable instructions comprise, for example, instructions and data which cause a general purpose computer, special purpose computer, or special purpose processing machines to perform a certain function or group of functions.

1. A gaming system comprising:
a mechanical reel;
an electronic display, the reel and display being constantly independently viewable; and
a game controller operatively coupled to the reel and the electronic display and configured to cause a visual event comprised of a reel portion and an electronic display portion which interact with one another.

2. A gaming system defined by claim 1 wherein a person playing on the gaming system is given the impression that the reel portion or the electronic display portion cause the other.

3. A gaming system comprising:
a mechanical reel;
an electronic display; and
a game controller operatively coupled to the reel and the electronic display and configured to cause a visual event comprised of a reel portion and an electronic display portion such that a person playing on the gaming system is given the impression that the electronic display portion or the reel portion cause the other.

4. A gaming system defined by claim 3 wherein the visual event occurs during a game playable on the gaming system.

5. A gaming system defined by claim 3 wherein the electronic display portion comprises an animation and the reel portion is the reel stopping on a certain symbol.

6. A gaming system defined by claim 5 wherein the animation is of the certain symbol moving on the electronic display.

7. A gaming system defined by claim 5 wherein the electronic display is located below the reel.

8. A gaming system defined by claim 5 wherein the animation is of the certain symbol falling.

9. A gaming system defined by claim 5 wherein the display is located above the reel.

10. A gaming system defined by claim 5 wherein the animation is of the certain symbol rising.

11. A gaming system defined by claim 5 wherein the animation is the appearance of the certain symbol on the electronic display.

12. A gaming system defined by claim 1 wherein the electronic display portion is indicative of a direction the reel spins.

13. A gaming system defined by claim 1 wherein the reel portion comprises the reel stopping at a certain symbol and the electronic display portion is consistently associated with the reel stopping at the certain symbol.

14. A gaming system defined by claim 1 wherein the electronic display portion is indicative of the reel being respun.

15. A gaming system defined by claim 1 wherein the controller causes the electronic display portion to start on or after the reel stops on a generic symbol.

16. A gaming system defined by claim 15 wherein the controller causes the generic symbol to change on or after the start of the electronic display portion.

17. A gamine machine defined by claim 16 wherein the electronic display portion is indicative of the change of the generic symbol.

18. A gaming system defined by claim 17 wherein the change is a change in a colour.

19. A gaming system defined by claim 1 wherein the gaming system comprises another electronic display, the controller being operatively coupled to the other electronic display, and the visual event is further comprised of another electronic display portion on the other electronic display.

20. A gaming system defined by claim 19 wherein the controller causes the electronic display portion, then the reel portion, and then the other electronic display portion.

21. A gaming system defined by claim 1 further comprising a display area wherein the reel and electronic display(s) form an array over the display area.

22. A gaming system defined by claim 21 wherein the array is horizontal.

23. A gaming system defined by claim 21 wherein the array is vertical.

24. A gaming system defined by claim 1 wherein the reel is adjacent to the electronic display(s).

25. A gaming system defined by claim 3 wherein the reel and display are constantly independently viewable.

26. A game controller configured to be operatively coupled to a reel and an electronic display and configured to cause a visual event comprised of a reel portion and an electronic display portion which interact with one another.

27. A game controller configured to be operatively coupled to both a reel and an electronic display and cause a visual event comprised of a reel portion and an electronic display portion such that a person playing on the gaming system is given the impression that the electronic display portion or the reel portion cause the other.

28. A gaming system comprising:
a mechanical reel simulated on an electronic display;
a moving image presentation area on the, or another, electronic display, the simulated mechanical reel and moving image presentation area being constantly independently viewable; and
a controller operatively coupled to the display(s) and configured to cause a visual event comprised of a reel portion and presentation area portion which interact with one another.

29. A gaming system comprising:
a mechanical reel simulated on an electronic display;
a moving image presentation area on the, or another, electronic display; and
a controller operatively coupled to the display(s) and configured to cause a visual event comprised of a reel portion and a presentation area portion such that a person playing on the gaming system is given the impression that one of the reel portion and the presentation portion cause the other.

30. A method comprising causing on a gaming system a visual event comprised of a reel portion and an electronic display portion which interact with one another.

31. A method comprising causing on a gaming system a visual event comprised of a reel portion and an electronic display portion such that a person is given the impression that one of the electronic display portion or the reel portion causes the other.

32. A tangible computer readable storage medium including computer program instructions for controlling a computer which, when executed by a computer processor, cause the computer to implement a method comprising: causing, on a gaming system, a visual event comprised of a reel portion and an electronic display portion which interact with one another.

33. A tangible computer readable storage medium including computer program instructions for controlling a computer which, when executed by a computer processor, cause the computer to implement a method comprising: causing, on a gaming system, a visual event comprised of a reel portion and an electronic display portion such that a person is given the impression that one of the electronic display portion or the reel portion causes the other.
